(19) United States
(12) Patent Application Publication
(10) Pub. No.: US 2025/0343481 A1
(43) Pub. Date: Nov. 6, 2025

(54) POWER CONVERTING DEVICE, SIGNAL PROCESSING DEVICE, AND ELECTRONIC DEVICE COMPRISING THE SAME

(71) Applicant: LG ELECTRONICS INC., Seoul (KR)

(72) Inventors: Donghyun KIM, Seoul (KR); Doohoon LEE, Seoul (KR); Hanul LEE, Seoul (KR); Jihyun KIM, Seoul (KR); Sungcheol SHIN, Seoul (KR); Youngjae JUNG, Seoul (KR); Sungwook HWANG, Seoul (KR)

(73) Assignee: LG ELECTRONICS INC., Seoul (KR)

(21) Appl. No.: 19/194,640

(22) Filed: Apr. 30, 2025

(30) Foreign Application Priority Data
May 2, 2024 (KR) 10-2024-0058577
Sep. 25, 2024 (KR) 10-2024-0130115

(51) Int. Cl. H02M 3/155; H02M 1/00; H02M 1/08

(52) U.S. Cl. CPC H02M 3/155; H02M 1/0009; H02M 1/08

(57) ABSTRACT

A power converting device, a signal processing device, and an electronic device including the same are disclosed. The power converting device includes a first switching element and a second switching element; a pulse width modulation (PWM) control circuit to output a PWM control signal based on a first voltage corresponding to a current flowing in an inductor having one end connected to the first and second switching elements or a second voltage corresponding to a voltage of a capacitor connected to the other end of the inductor; and a pulse frequency modulation (PFM) control circuit to output a PFM control signal based on the current flowing in the inductor or the voltage of the capacitor, wherein the PWM control circuit is configured to adjust the first voltage, during mode switching between a PFM mode and a PWM mode.

### CROSS-REFERENCE TO THE RELATED APPLICATIONS

Pursuant to 35 U.S.C. § 119(a), this application claims the benefit of earlier filing date and right of priority to Korean Patent Application Nos. 10-2024-0058577, filed on May 2, 2024 and 10-2024-0130115, filed on Sep. 25, 2024, the contents of which are all hereby incorporated by reference herein in their entirety.

### BACKGROUND

### 1. Field

This disclosure relates to a power converting device, a signal processing device, and an electronic device including the same, and more specifically, to a power converting device, a signal processing device, and an electronic device having the same capable of reducing a voltage ripple during mode switching.

### 2. Description of the Related Art

Electronic devices operate based on voltage from an internal power converting device.

Meanwhile, when there is a load fluctuation within an electronic device, in order to achieve high efficiency over a wide load current range, two or more modes, not just one mode, must be used.

Therefore, the power converting device can operate in a pulse frequency modulation (PFM) mode at light load, and operate in a pulse width modulation (PWM) mode at heavy load.

The pulse frequency modulation mode exhibits high operating efficiency at light load, but has a significant ripple in the output voltage, while the pulse width modulation mode has a small output voltage ripple.

Meanwhile, in response to switching between the pulse frequency modulation mode and the pulse width modulation mode, there is significant ripple in the output voltage.

### SUMMARY

The disclosure has been made in view of the above problems, and may provide a power converting device, a signal processing device, and an electronic device including the same capable of reducing a voltage ripple during mode switching.

The disclosure may further provide a power converting device, a signal processing device, and an electronic device including the same capable of reducing voltage ripple during mode switching between a pulse frequency modulation mode and a pulse width modulation mode.

In accordance with an aspect of the present disclosure, a power converting device, a signal processing device, and an electronic device having the same include a first switching element; a second switching element between the first switching element and a ground terminal; a pulse width modulation control circuit configured to output a pulse width modulation control signal based on a first voltage corresponding to a current flowing in an inductor having one end connected to the first switching element and the second switching element or a second voltage corresponding to a voltage of a capacitor connected to the other end of the inductor; and a pulse frequency modulation control circuit configured to output a pulse frequency modulation control signal based on the current flowing in the inductor or the voltage of the capacitor, in which the pulse width modulation control circuit is configured to adjust the first voltage, during mode switching between a first mode, which is a pulse frequency modulation mode, and a second mode, which is a pulse width modulation mode.

Meanwhile, in response to switching from the first mode to the second mode, the pulse width modulation control circuit is configured to change the first voltage based on the current flowing in the inductor or the voltage of the capacitor.

Meanwhile, the pulse width modulation control circuit is configured to increase the first voltage, as the current flowing in the inductor increases or the voltage of the capacitor decreases, in response to switching from the first mode to the second mode.

Meanwhile, the pulse width modulation control circuit is configured to increase the first voltage and the second voltage from a second time point before the first time point, in response to a switching time from the first mode to the second mode being a first time point.

Meanwhile, in response to a switching time from the first mode to the second mode being a first time point, the pulse width modulation control circuit is configured to operate from a second time point before the first time point, and control a level of the second voltage at the first time point to be greater than a level of the first voltage.

Meanwhile, in response to a switching time from the first mode to the second mode being a first time point, the pulse width modulation control circuit is configured to control a pulse width of pulse voltage applied to the inductor to be constant, for a certain period of time after the first time point.

Meanwhile, in response to a switching time from the first mode to the second mode being a first time point, the pulse width modulation control circuit is configured to control a level of the second voltage to be constant, for a certain period of time after the first time point.

Meanwhile, in response to a switching time from the first mode to the second mode being a first time point, the pulse width modulation control circuit is configured to change a level of the first voltage corresponding to an offset voltage and a ramp pulse voltage, for a certain period of time after the first time point.

Meanwhile, in response to the switching time from the first mode to the second mode being the first time point, the pulse width modulation control circuit is configured to change the level of the first voltage, by changing the offset voltage among the offset voltage and the ramp pulse voltage, for the certain period of time after the first time point.

Meanwhile, the pulse width modulation control circuit includes: a current sensor configured to sense the current flowing in the inductor; a ramp output portion configured to output a ramp pulse voltage; a current controller configured to output a third current corresponding to a first current based on the current sensor and a second current based on the ramp output portion; an adder configured to add the first current, the second current, and the third current and output the first voltage; and a comparator configured to compare the first voltage and the second voltage and output the pulse width modulation control signal.

Meanwhile, the pulse width modulation control circuit further includes: an error amplifier configured to operate based on the third voltage corresponding to the voltage of the capacitor and a reference voltage; and a second capacitor arranged between the first comparator and the error amplifier.

Meanwhile, the pulse frequency modulation control circuit includes: a second comparator configured to operate based on a third voltage corresponding to the voltage of the capacitor and a reference voltage; a second current sensor configured to sense the current flowing in the inductor; and a multiplexer configured to output the pulse frequency modulation control signal based on an output signal of the second comparator and an output signal of the second current sensor.

Meanwhile, the power converting device, the signal processing device, and the electronic device having the same according to an aspect of the present disclosure further include a switching controller configured to complementarily operate the first switching element and the second switching element, based on the pulse width modulation control signal from the pulse width modulation control circuit or the pulse frequency modulation control signal from the pulse frequency modulation control circuit.

Meanwhile, the switching controller includes a second multiplexer configured to operates based on the pulse width modulation control signal from the pulse width modulation control circuit or the pulse frequency modulation control signal from the pulse frequency modulation control circuit; a multiplexer controller configured to control the second multiplexer; a dead time controller configured to control dead time control based on a signal from the second multiplexer; and a switch buffer configured to output a switching control signal to each of the first switching element and the second switching element based on signal from the dead time controller.

Meanwhile, the power converting device, the signal processing device, and the electronic device having the same according to an aspect of the present disclosure further include an inductor having one end connected to the first switching element and the second switching element; and a capacitor connected to the other end of the inductor.

### BRIEF DESCRIPTION OF THE DRAWINGS

The above and other objects, features and advantages of the present disclosure will be more apparent from the following detailed description in conjunction with the accompanying drawings, in which:

FIG. 1 is a diagram illustrating various examples of an electronic device according to an embodiment of the present disclosure;

FIG. 2 is an example of an internal block diagram of the electronic device of FIG. 1;

FIG. 3A is an example of a power converting device related to the present disclosure;

FIGS. 3B to 3E are diagrams for explaining FIG. 3A;

FIG. 4 is an example of a power converting device according to an embodiment of the present disclosure; and

FIGS. 5 to 8 are diagrams for explaining FIG. 4.

### DETAILED DESCRIPTION

Hereinafter, the present disclosure will be described in more detail with reference to the drawings.

The suffixes such as “module” and “unit” may be used to refer to elements or components. Use of such suffixes herein is merely intended to facilitate description of the specification, and the suffixes do not have any special meaning or function. Accordingly, the “module” and “unit” may be used interchangeably.

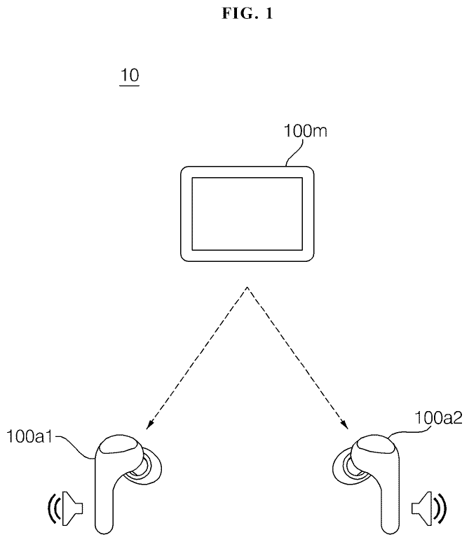

FIG. 1 is a diagram illustrating various examples of an electronic device according to an embodiment of the present disclosure.

Referring to FIG. 1, a wireless audio system 10 according to an embodiment of the present disclosure may include a wireless audio transmitting device 100m, which is an example of an electronic device, and a wireless audio receiving device 100a1, 100a2, which is another example of an electronic device.

For example, the wireless audio transmitting device 100m may transmit a wireless audio signal to the wireless audio receiving device 100a1, 100a2, based on Bluetooth communication, WiFi communication, or ultra-wideband (UWB) communication.

In response, the wireless audio receiving device 100a1, 100a2 may output a sound corresponding to the received wireless audio signal.

For example, the wireless audio transmitting device 100m may be a mobile terminal, a tablet PC, a laptop PC, a TV, a vehicle display device, etc.

Meanwhile, the wireless audio receiving device 100a1, 100a2 may be a wireless audio output device, a mobile terminal, a tablet PC, a laptop PC, a TV, a vehicle display device, a home appliance such as a refrigerator, etc.

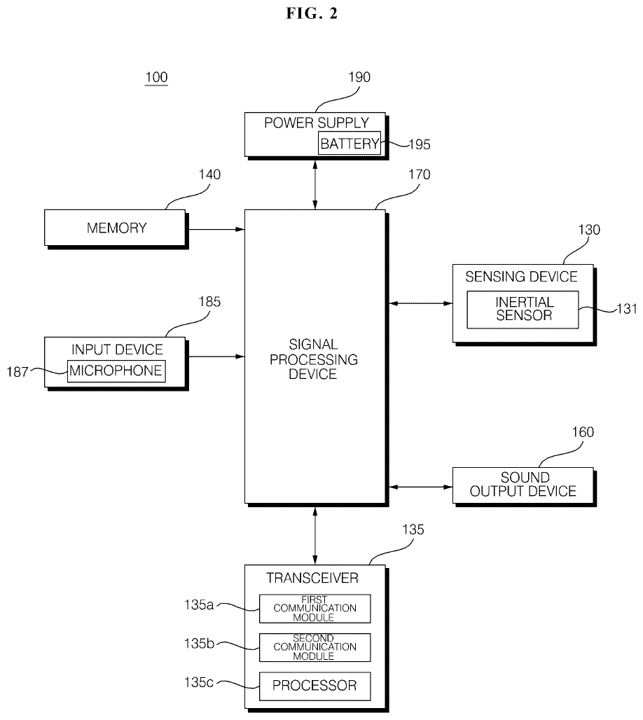

FIG. 2 is an example of an internal block diagram of the electronic device of FIG. 1.

Referring to FIG. 2, the electronic device 100 may include a sensing device 130, a transceiver 135, a memory 140, a sound output device 160, a signal processing device 170, an input device 185, and a power supply 190. When these components are implemented in actual applications, if necessary, two or more components may be combined into one component, or one component may be subdivided into two or more components.

The sensing device 130 may include an inertial sensor 131. The inertial sensor may include an acceleration sensor, a gyro sensor, a gravity sensor, or the like. For example, the acceleration sensor, the gyro sensor, the gravity sensor, or the like may include a 6-axis sensor.

The sensing device 130 may output motion information of the electronic device 100, for example, movement information acceleration information, angular velocity information or location information based on x, y, z axis.

Meanwhile, the sensing device 130 may include a sensor for obtaining user body information. For example, a blood pressure sensor, a brain wave sensor, or the like may be provided.

Meanwhile, the transceiver 135 may provide an interface for communication with an external device. To this end, the transceiver 135 may include at least one of a mobile communication module (not shown), a wireless Internet module (not shown), a short-distance communication module (not shown), or a GPS module (not shown).

For example, the transceiver 135 may perform IR communication, Bluetooth communication, WiFi communication, or Ultra-Wideband (UWB) communication, thereby exchanging data with a paired wireless audio transmitting device 100m or transmitting data. In particular, it may receive an audio signal from the paired wireless audio transmitting device 100m.

Meanwhile, the transceiver 135 may include a first communication module 135a that wirelessly receives a first audio signal according to a first communication standard of a first frequency band, and a second communication module 135b that wirelessly receives a second audio signal according to a second communication standard of a second frequency band greater than the first frequency band.

Meanwhile, the transceiver 135 may further include a signal processing device 135c for signal processing or control of the first communication module 135a and the second communication module 135b.

Meanwhile, the first communication module 135a receives a first signal data through a first channel CH1, and separately receives a first audio data through a second channel CH2, and the second communication module 135b separately receives a second signal data and a second audio data through the same channel CHm.

Accordingly, even when the wireless environment is complicated, it is possible to stably receive audio wirelessly and output sound. In addition, signal data and audio data can be distinguished in the first communication module 135a and the second communication module 135b, so that audio can be stably received wirelessly and sound can be output.

Meanwhile, the beacon signal received by the second communication module 135b may include unicast information or broadcast information. Accordingly, it is possible to operate by dividing into unicast and broadcast.

Meanwhile, when unicast information is included in the received beacon signal, the second communication module 135b may transmit association request information to the wireless audio transmitting device 50 or 100, and may receive association response information from the wireless audio transmitting device 50 or 100. Accordingly, it is possible to operate by dividing into unicast and broadcast.

Meanwhile, the second communication module 135b may distinguish whether it is the second signal data or the second audio data, based on identification information in the header among the received second audio signal. Accordingly, signal data and audio data can be distinguished, thereby stably receiving audio wirelessly and outputting sound.

Meanwhile, the second communication module 135b may distinguish whether it is the second signal data or the second audio data, based on identification information in a media access control MAC header or a physical PHY header among the received second audio signal. Accordingly, signal data and audio data can be distinguished, thereby stably receiving audio wirelessly and outputting sound.

Meanwhile, when receiving the second signal data, the second communication module 135b may extract encoding or decoding information of the second standard, and based on the extracted encoding or decoding information, may receive the second audio data after the second signal data, and may set a replay time of the second audio data. Accordingly, signal data and audio data can be distinguished, thereby stably receiving audio wirelessly and outputting sound.

The memory 140 may store programs for processing or controlling the signal processing device 170 in the electronic device 100, or may perform a function for temporarily storing input or output data.

The sound output device 160 may output an audio signal processed by the signal processing device 170 in the electronic device 100.

Alternatively, the sound output device 160 may output guide information related to the operation of the electronic device 100 as an audio signal.

Meanwhile, the sound output device 160 may output a first sound corresponding to the first audio signal from the first communication module 135a or a second sound corresponding to the second audio signal from the second communication module 135b.

The signal processing device 170 may control the overall operation of the electronic device 100 by controlling the operation of each unit in the electronic device 100.

Meanwhile, the signal processing device 170 may perform signal processing for an audio signal received from the outside.

Meanwhile, the signal processing device 170 may replay an audio signal from the first communication module 135a or the second communication module 135b.

Meanwhile, the signal processing device 170 may replay the second audio data, based on the decoding information from the second communication module 135b and a set replay time. Accordingly, signal data and audio data can be distinguished, thereby stably receiving audio wirelessly and outputting sound.

Meanwhile, the input device 185 may include a button for initializing the electronic device 100, or inputting an operation.

Meanwhile, the input device 185 may include a microphone 187 for sound collection.

Meanwhile, the input device 185 may include a camera (not shown) for capturing images.

For example, as shown in FIG. 2A, the input device 185 may include a power key (185a) for turning power on or off, a FF/REW key (185b) for going forward or backward in the reproducing audio, a volume key (185c) for volume up or down, a pause/play key (185d) for playing or pausing audio, and the like.

The power supply 190 may supply power required for operation of each component under the control of the signal processing device 170.

In particular, the power supply 190 may include a battery 195 that stores and outputs DC power.

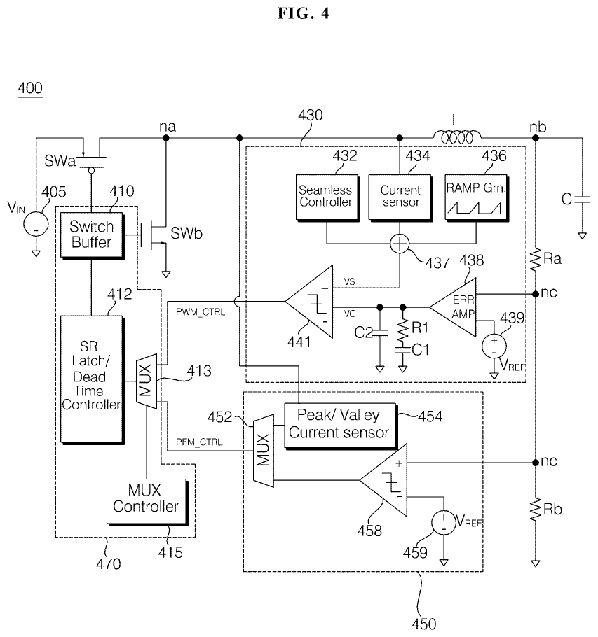

Meanwhile, the signal processing device 170 according to an embodiment of the present disclosure may be equipped with a power converting device 400 such as FIG. 4 described later.

As another example, the power supply 190 according to an embodiment of the present disclosure may also be equipped with a power converting device 400 such as FIG. 4.

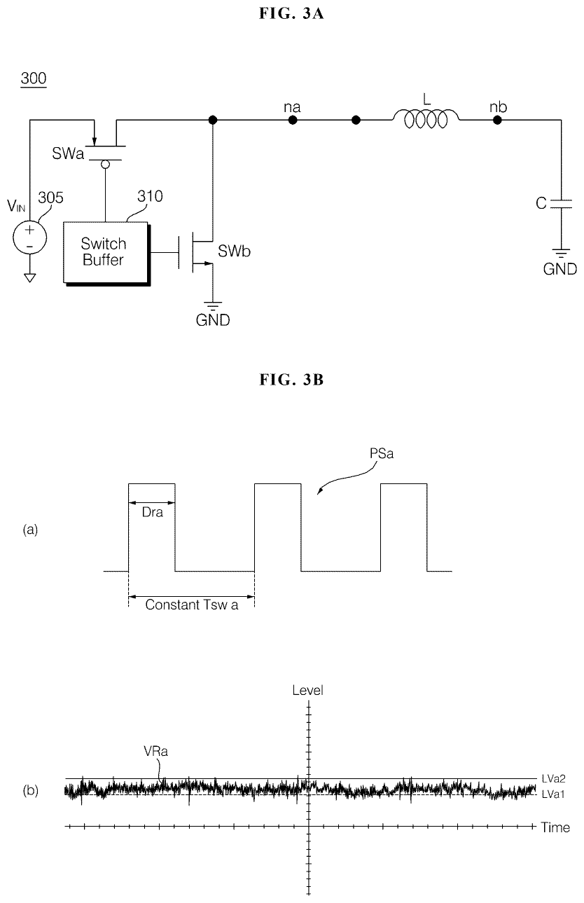

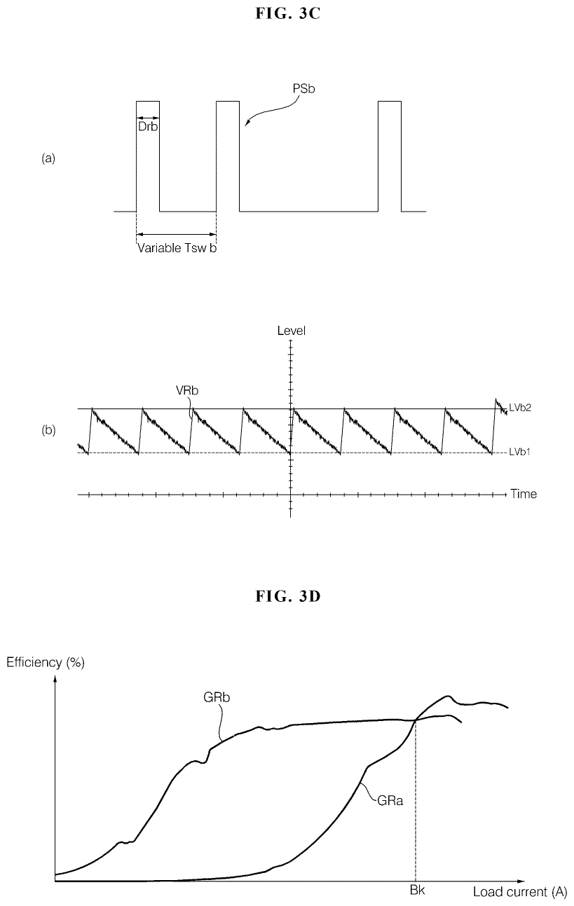

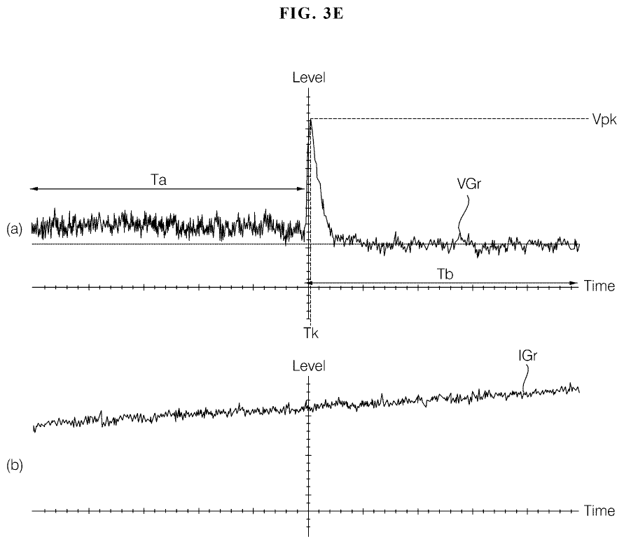

FIG. 3A is an example of a power converting device related to the present disclosure.

Referring to FIG. 3A, the power converting device 300 in the electronic device 100 may convert and output the level of a first DC voltage Vin from an input DC power source 305.

For example, the power converting device 300 related to the present disclosure may include a first switching element SWa, a second switching element SWb between the first switching element SWa and a ground terminal, an inductor L having one end connected to the first switching element SWa and the second switching element SWb, and a capacitor C connected to the other end of the inductor L.

That is, the first switching element SWa may be arranged between an na node and the DC power source 305, the second switching element SWb may be arranged between the na node and the ground terminal GND, the inductor L may be arranged between the na node and a nb node, and the capacitor C may be arranged between the nb node and the ground terminal GND.

Meanwhile, when there is a load fluctuation in an electronic device, in order to achieve high efficiency in a wide load current range, the power converting device 300 related to the present disclosure may be configured to operate in a pulse frequency modulation (PFM) mode at a light load, and operate in a pulse width modulation (PWM) mode at a heavy load.

FIGS. 3B to 3E are diagrams for explaining FIG. 3A.

FIG. 3B illustrates that the power converting device 300 of FIG. 3A operates in a PWM mode.

Referring to the drawings, the power converting device 300 related to the present disclosure may control the first switching element SWa and the second switching element SWb that operate complementarily to each other to operate in the PWM mode.

That is, as in FIG. 3B (a), the first switching element SWa or the second switching element SWb operates, based on a first pulse signal PSa in which a pulse cycle is fixed to TSW a and the duty Dra is variable.

According to the first pulse signal PSa, as in FIG. 3B (b), the ripple of the output voltage VRa of the power converting device 300 becomes small.

In the drawing, it is illustrated that the ripple of the output voltage VRa of the power converting device 300 lies between LVa1 and LVa2.

FIG. 3C illustrates that the power converting device 300 of FIG. 3A operates in the PFM mode.

Referring to FIG. 3C, the power converting device 300 related to the present disclosure can control the first switching element SWa and the second switching element SWb, which operate complementarily to each other, to operate in the PFM mode.

That is, as in FIG. 3C (a), the first switching element SWa or the second switching element SWb operates, based on a second pulse signal PSb in which a pulse cycle is variable such as TSW b and the duty Drb is constant.

According to the second pulse signal PSb, as in FIG. 3C (b), the ripple of the output voltage VRb of the power converting device 300 becomes large.

In the drawing, it is illustrated that the ripple of the output voltage VRb of the power converting device 300 lies between LVb1 and LVb2.

FIG. 3D illustrates the efficiency versus load current of the power converting device 300 of FIG. 3A.

Referring to FIG. 3D, it is preferable that the power converting device 300 of FIG. 3A operates in the PFM mode, like GRb, when the load current is a light load that is less than Bk, and operates in the PWM mode, like GRa, when the load current is a heavy load that is equal to or higher than Bk.

Accordingly, the operating efficiency of the power converting device 300 of FIG. 3A can be improved.

However, according to the power converting device 300 of FIG. 3A, there is a disadvantage in that there is a significant ripple in the output voltage when the operation is switched from the PFM mode to the PWM mode, or when the operation is switched from the PWM mode to the PFM mode.

FIG. 3E illustrates an example of the output voltage, etc., when the operation is switched from the PFM mode to the PWM mode in the power converting device 300 of FIG. 3A.

Referring to FIG. 3E, during the Ta period before the Tk time point, the power converting device 300 operates in the PFM mode, and during the Tb period after the Tk time point, the power converting device 300 operates in the PWM mode.

FIG. 3E (a) illustrates the waveform VGr of the output voltage of the power converting device 300, and FIG. 3E (b) illustrates the waveform IGr of the load current or output current of the power converting device 300.

Meanwhile, after the Tk time point when the operation is switched from the PFM mode to the PWM mode, the waveform VGr of the output voltage of the power converting device 300 may rapidly increase to the peak voltage Vpk. Furthermore, the ripple of the output voltage of the power converting device 300 may also significantly increase. Accordingly, deterioration may occur in the circuit elements of the power converting device 300.

Meanwhile, in the case where the operation switching from PFM mode to PWM mode or from PWM mode to PFM mode in the power converting device 300 of FIG. 3A occurs frequently, the peak voltage Vpk or the ripple of the output voltage occurs frequently, so that deterioration may occur in the circuit elements of the power converting device 300.

Accordingly, the present disclosure proposes a method for reducing the voltage ripple during mode switching. This will be described with reference to FIG. 4 and below.

FIG. 4 is an example of a power converting device according to an embodiment of the present disclosure.

Referring to FIG. 4, a power converting device 400 according to an embodiment of the present disclosure includes a first switching element SWa, a second switching element SWb between the first switching element SWa and a ground terminal, a pulse width modulation control circuit 430 that outputs a pulse width modulation control signal PWM_CTRL, based on a first voltage vs corresponding to a current flowing in an inductor L having one end connected to the first switching element SWa and the second switching element SWb or a second voltage vc corresponding to a voltage of a capacitor C connected to the other end of the inductor L, and a pulse frequency modulation control circuit 450 that outputs a pulse frequency modulation control signal PFM_CTRL based on the current flowing in the inductor L or the voltage of the capacitor C.

Meanwhile, the pulse width modulation control circuit 430 controls the first voltage vs, in response to switching between the first mode, which is a pulse frequency modulation mode, and the second mode, which is a pulse width modulation mode. Accordingly, the voltage ripple during mode switching can be reduced.

In particular, the voltage ripple during mode switching between the pulse frequency modulation mode and the pulse width modulation mode can be reduced.

Meanwhile, the power converting device 400 according to an embodiment of the present disclosure may further include an inductor L having one end connected to the first switching element SWa and the second switching element SWb, and a capacitor C connected to the other end of the inductor L.

For example, when the power converting device 400 is provided inside the signal processing device 170 of FIG. 2, the inductor L and the capacitor C can also be separately arranged outside the signal processing device 170.

Meanwhile, the first switching element SWa may be arranged between the na node and a DC power source 405, the second switching element SWb may be arranged between the na node and the ground terminal GND, the inductor L may be arranged between the na node and the nb node, and the capacitor C may be arranged between the nb node and the ground terminal GND.

Meanwhile, a first resistance element Ra and a second resistance element Rb may be connected to between the nb node and the ground terminal GND.

Meanwhile, the pulse width modulation control circuit 430 may be configured to change the first voltage vs, based on the current flowing in the inductor L or the voltage of the capacitor C, in response to switching from the first mode to the second mode. Accordingly, voltage ripple during mode switching can be reduced.

Meanwhile, the pulse width modulation control circuit 430 may be configured to increase the first voltage vs, as the current flowing through the inductor L increases or the voltage VC of the capacitor C decreases, in response to switching from the first mode to the second mode. Accordingly, the voltage ripple during mode switching can be reduced.

Meanwhile, the pulse width modulation control circuit 430 may include a current sensor 434 that senses the current flowing in the inductor L, a ramp output portion 436 that outputs a ramp pulse voltage, a current controller 432 that outputs a third current Iseamless in response to a first current Ics based on the current sensor 434 and a second current Iramp based on the ramp output portion 436, a adder 437 that outputs a first voltage vs by adding the first current Ics, the second current Iramp, and the third current Iseamless, and a comparator 441 that compares the first voltage vs and the second voltage vc and outputs a pulse width modulation control signal PWM_CTRL.

Meanwhile, a first voltage vs may be input to one end of an input terminal of the comparator 441, and a second voltage vc may be input to the other end of the input terminal of the comparator 441.

Meanwhile, the pulse width modulation control circuit 430 may further include an error amplifier 438 that operates based on a third voltage Vnc corresponding to the voltage of a capacitor C and a reference voltage Vref, and a second capacitor C2 that is arranged between the first comparator 441 and the error amplifier 438.

Meanwhile, the current sensor 434 may be connected to the na node.

Meanwhile, the voltage Vnc of the nc node, which is a node between the first resistance element Ra and the second resistance element Rb, may be input to one end of the input terminal of the error amplifier 438, and a reference voltage Vref from a reference voltage source 439 may be input to the other end of the input terminal of the error amplifier 438.

Meanwhile, the pulse width modulation control circuit 430 may further include a resistance element R1 and a third capacitor C1 arranged between the first comparator 441 and the error amplifier 438.

At this time, the resistance element R1 and the third capacitor C1 may be connected in parallel to the second capacitor C2.

Meanwhile, the pulse frequency modulation control circuit 450 may include a second comparator 458 that operates based on a third voltage Vnc corresponding to the voltage of the capacitor C and a reference voltage Vref, a second current sensor 454 that senses the current flowing in the inductor L, and a multiplexer 452 that outputs a pulse frequency modulation control signal PFM_CTRL based on the output signal of the second comparator 458 and the output signal of the second current sensor 454.

Meanwhile, the second current sensor 454 may be connected to the na node.

Meanwhile, the third voltage Vnc of the nc node, which is a node between the first resistance element Ra and the second resistance element Rb, may be input to one end of the input terminal of the second comparator 458, and the reference voltage Vref from the reference voltage source 459 may be input to the other end of the input terminal of the second comparator 458.

Meanwhile, the power converting device 400 according to an embodiment of the present disclosure may further include a switching controller 470 configured to complementarily operate the first switching element SWa and the second switching element SWb, based on a pulse width modulation control signal PWM_CTRL from the pulse width modulation control circuit 430 or a pulse frequency modulation control signal PFM_CTRL from the pulse frequency modulation control circuit 450.

Meanwhile, the switching controller 470 may include a second multiplexer 413 that operates based on a pulse width modulation control signal PWM_CTRL from the pulse width modulation control circuit 430 or a pulse frequency modulation control signal PFM_CTRL from the pulse frequency modulation control circuit 450, a multiplexer controller 415 that controls the second multiplexer 413, a dead time controller 412 that controls dead time control based on a signal from the second multiplexer 413, and a switch buffer 410 that outputs a switching control signal to each of the first switching element SWa and the second switching element SWb, based on a signal from the dead time controller 412.

Meanwhile, the power converting device 400 according to an embodiment of the present disclosure may be configured to previously increase the second voltage vc, which is a voltage input to the other end of the input terminal of the comparator 441, in response to switching between the first mode, which is a pulse frequency modulation mode, and the second mode, which is a pulse width modulation mode.

Meanwhile, the voltage rising slope of the second voltage vc may correspond to the resistance element R1, the second capacitor C2, and the third capacitor C1.

For example, the voltage rising slope of the second voltage vc may be inversely proportional to the rc time constant.

Specifically, as the resistance element R1 becomes smaller and the capacitance of the second capacitor C2 or the third capacitor C1 becomes smaller, the voltage rising slope of the second voltage vc may become larger.

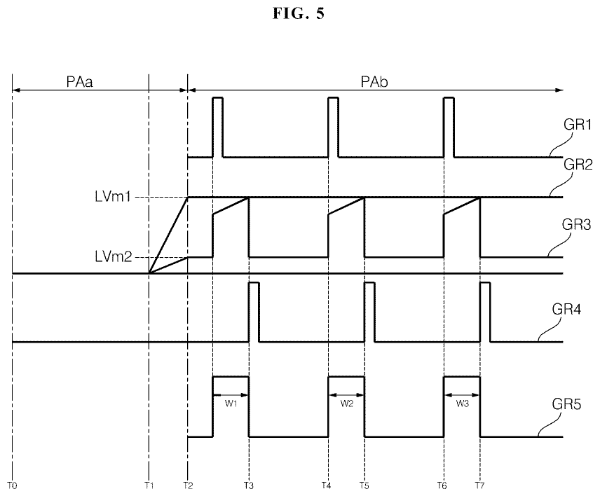

FIGS. 5 to 8 are diagrams for explaining FIG. 4.

First, FIG. 5 illustrates an example of various operation waveforms within the power converting device 400 of FIG. 4.

Referring to FIG. 5, GR1 represents a signal from the dead time controller 412, GR2 represents a signal of the second voltage vc input to the other end of the input terminal of the comparator 441, GR3 represents a signal of the first voltage vs input to one end of the input terminal of the comparator 441, GR4 represents a pulse width modulation control signal PWM_CTRL which is a signal of the output terminal of the comparator 441, and GR5 may represent a signal of the voltage of the na node or a pulse voltage GR5 applied to the inductor L.

Meanwhile, the power converting device 400 of FIG. 4 preferably operates in the PFM mode when the load current is a light load less than a set value, and operates in the PWM mode when the load current is a heavy load that is equal to or greater than the set value.

That is, as shown in the drawing, during the PAa period before time point T2, the power converting device 400 operates in the PFM mode, and during the PAb period after time point T2, the power converting device 400 operates in the PWM mode.

That is, during the PAa period between To and T2, the power converting device 400 operates in the PFM mode, and during the PAb period after T2 to T7, the power converting device 400 operates in the PWM mode.

Meanwhile, the pulse width modulation control circuit 430 may be configured to increase the first voltage vs and the second voltage vc from a second time point T1 before a first time point T2, when the switching time from the first mode, which is a pulse frequency modulation PFM mode, to the second mode, which is a pulse width modulation PWM mode, is a first time point T2.

At this time, in response to the switching time from the first mode to the second mode being the first time point T2, the pulse width modulation control circuit 430 may be configured to operate from the second time point T1 before the first time point T2, and control the level LVm1 of the second voltage vc to be greater than the level LVm2 of the first voltage vs at the first time point T2.

That is, the pulse width modulation control circuit 430 may be configured to control the rising slope of the second voltage vc to be greater than the rising slope of the first voltage vs, during the period between the second time point T1 and the first time point T2.

To this end, as shown in FIG. 4, the pulse width modulation control circuit 430 may be equipped with a resistance element R1, a second capacitor C2, a third capacitor C1, etc.

Meanwhile, at a third time point between the time point T2 and the time point T3, a high level signal is output from the dead time controller 412, and in response to this, the current sensor 434 and the ramp output portion 436 operate respectively.

Accordingly, the adder 437 is configured to add the first current ICs based on the voltage from the current sensor 434, the second current Iramp based on the ramp pulse voltage from the ramp output portion 436, and the third current Iseamless based on the offset voltage from the current controller 432, from the third time point to time point T3.

Eventually, from the third time point to time point T3, the first voltage vs input to one end of the input terminal of the comparator 441 appears as a ramp pulse voltage to which an offset voltage is added, like GR3.

Meanwhile, in response to the first voltage vs from the third time point to the T3 time point, a pulse width modulation control signal PWM_CTRL may be output, at the T3 time point.

Accordingly, between the third time point and the T3 time point, a pulse voltage GR5 applied to the inductor L is applied, like GR5, and the duty of the pulse voltage GR5 at this time may be W1.

Similarly, at a fourth time point between the T4 time point and the T5 time point, a high level signal is output from the dead time controller 412, and in response to this, the current sensor 434 and the ramp output portion 436 operate, respectively.

Accordingly, the adder 437 is configured to add the first current ICs based on the voltage from the current sensor 434 from the fourth time point to the T5 time point, the second current Iramp based on the ramp pulse voltage from the ramp output portion 436, and the third current Iseamless based on the offset voltage from the current controller 432.

Eventually, from the fourth time point to the T5 time point, the first voltage vs input to one end of the input terminal of the comparator 441 appears as a ramp pulse voltage to which an offset voltage is added, like GR3.

Meanwhile, a pulse width modulation control signal PWM_CTRL can be output in response to the first voltage vs from the fourth time point to the T5 time point, at the T5 time point.

Accordingly, between the fourth time point and the T5 time point, a pulse voltage GR5 is applied to the inductor L, like GR5, and the duty of the pulse voltage GR5 at this time may be W2.

Similarly, at a fifth time point between the T6 time point and the T7 time point, a high level signal is output from the dead time controller 412, and in response to this, the current sensor 434 and the ramp output portion 436 operate, respectively.

Accordingly, from the fifth time point to the T7 time point, the adder 437 is configured to add the first current ICs based on the voltage from the current sensor 434, the second current Iramp based on the ramp pulse voltage from the ramp output portion 436, and the third current Iseamless based on the offset voltage from the current controller 432.

Eventually, from the fifth time point to the T7 time point, the first voltage vs input to one end of the input terminal of the comparator 441 appears as a ramp pulse voltage to which an offset voltage is added, like GR3.

Meanwhile, a pulse width modulation control signal PWM_CTRL may be output in response to the first voltage vs from the fifth time point to the T7 time point, at the T7 time point.

Accordingly, between the fifth time point and the T7 time point, a pulse voltage GR5 is applied to the inductor L, like GR5, and the duty of the pulse voltage GR5 at this time may be W3.

Meanwhile, in the drawing, it is illustrated that the width of the pulse voltage applied to the inductor L is W1, W2, and W3, but, unlike this, the same width may also be possible.

That is, when the switching time from a first mode to a second mode is the first time point T2, the pulse width modulation control circuit 430 may be configured to control the pulse width of the plurality of pulse voltages GR5 applied to the inductor L to be the same as W1, during the periods T2 to T7, after the first time point T2. Accordingly, the output voltage of the power converting device 400 may be maintained constant without rising or falling, and as a result, the voltage ripple during mode switching may be reduced.

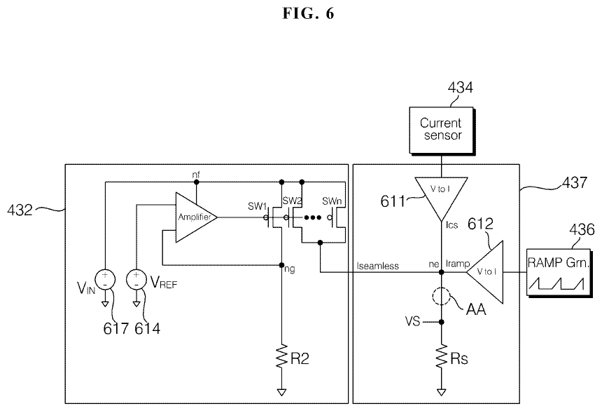

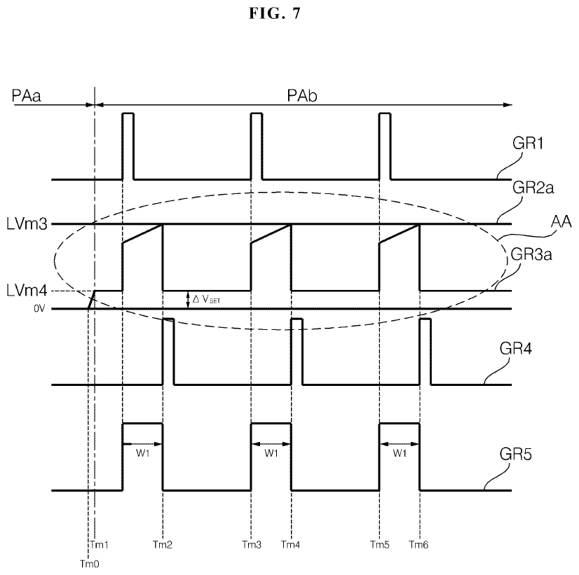

FIG. 6 illustrates an example of an internal circuit of the current controller 432 and the adder 437 of FIG. 4.

Referring to FIG. 6, the current controller 432 may include an input voltage source 617 that outputs an input voltage Vin, a reference voltage source 614 that outputs a reference voltage Vref, an amplifier, a plurality of switching elements SW1 to SWn that are connected in parallel with each other, and a resistance element R2 that is connected to partial switching element SW1 among the plurality of switching elements SW1 to SWn.

The other elements SW2 to SWn among the plurality of switching elements SW1 to SWn are connected in parallel, and may output a third current Iseamless that corresponds to the current flowing through partial switching element SW1 and the resistance element R2.

That is, an input voltage source 617 is connected to the nf node, and one end of a plurality of switching elements SW1 to SWn is connected in parallel to the nf node.

Meanwhile, a resistance element R2 is connected between the ng node, which is the other end of partial switching element SW1, and the ground terminal GND.

Meanwhile, a reference voltage Vref may be input to one end of the input terminal of the amplifier, and the voltage of the ng node may be input to the other end of the input terminal of the amplifier.

Meanwhile, the output terminal of the amplifier may be connected to the gate terminal of each switching element SW1 to SWn.

Meanwhile, the adder 437 may include a first converter 611 that converts a voltage from the current sensor 434 into a first current Ics, a second converter 612 that converts a ramp pulse voltage from the ramp output portion 436 into a second current Iramp, and a resistance element Rs.

Meanwhile, the output terminal of the second converter 612 may be connected to the ne node, which is an output terminal of the first converter 611, and the output terminal of the other elements SW2 to SWn among the plurality of switching elements SW1 to SWn may be connected to the ne node, and the ne node may be connected to one end of the resistance element Rs.

Accordingly, the adder 437 may output the first voltage vs by adding the first current Ics, the second current Iramp, and the third current Iseamless based on the offset voltage.

Meanwhile, the third current Iseamless may correspond to {vc−(Ics+Iramp)×Rs}/Rs. At this time, vc may correspond to the second voltage.

Meanwhile, the second voltage vc may be configured to change depending on the load fluctuation.

That is, the pulse width modulation control circuit 430 may be configured to change the first voltage vs, based on the first current ICs corresponding to the current flowing in the inductor L or the voltage VC of the capacitor C, in response to switching from the first mode to the second mode. Accordingly, the voltage ripple during mode switching can be reduced.

For example, in response to switching from the first mode to the second mode, the pulse width modulation control circuit 430 may be configured to increase the first voltage vs as the first current Ics corresponding to the current flowing in the inductor L increases or as the voltage VC of the capacitor C decreases. Accordingly, the voltage ripple during mode switching can be reduced.

Meanwhile, in response to switching from the first mode to the second mode, the pulse width modulation control circuit 430 may be configured to increase the second voltage vc, as the first current Ics corresponding to the current flowing through the inductor L increases or as the voltage VC of the capacitor C decreases. Accordingly, the voltage ripple during mode switching can be reduced.

Meanwhile, the third current Iseamless based on the offset voltage from the current controller 432 may be changed.

For example, as the voltage VC of the capacitor C decreases, the current controller 432 may be configured to increase the third current Iseamless based on the offset voltage. Accordingly, the voltage ripple during mode switching can be reduced.

Meanwhile, as the first current Ics corresponding to the current flowing through the inductor L increases, the current controller 432 may be configured to increase the third current Iseamless based on the offset voltage. Accordingly, the voltage ripple during mode switching can be reduced.

FIG. 7 is a drawing referred to in the operation description of FIG. 6.

Referring to FIG. 7, GR1 represents a signal from the dead time controller 412, GR2a represents a signal of the second voltage vc input to the other end of the input terminal of the comparator 441, GR3a represents a signal of the first voltage vs input to one end of the input terminal of the comparator 441, GR4 represents a pulse width modulation control signal PWM_CTRL which is a signal of the output terminal of the comparator 441, and GR5 represent a signal of the voltage of the na node or the pulse voltage GR5 applied to the inductor L.

In response to the AA area of FIG. 6, GR3 corresponding to the signal of the first voltage vs in FIG. 7 is illustrated.

Meanwhile, it is preferable that the power converting device 400 of FIG. 4 operates in PFM mode when the load current is a light load less than a set value, and operates in PWM mode when the load current is a heavy load equal to or more than the set value.

That is, as shown in FIG. 6, during the PAa period before the Tm1 time point, the power converting device 400 operates in PFM mode, and during the PAb period after the Tm1 time point, the power converting device 400 operates in PWM mode.

That is, during the PAa period up to Tm1, the power converting device 400 operates in PFM mode, and during the PAb period after Tm1 to Tm6, the power converting device 400 operates in PWM mode.

Meanwhile, the pulse width modulation control circuit 430 may be configured to increase the first voltage vs and the second voltage vc before the first time point Tm1, when the switching time from the first mode, which is a pulse frequency modulation PFM mode, to the second mode, which is a pulse width modulation PWM mode, is the first time point Tm1.

In the drawing, the first voltage vs increases from the second time point Tm0 before the first time point Tm1, and the second voltage ve increases prior to the first voltage vs.

At this time, the pulse width modulation control circuit 430 may be configured to control the level LVm3 of the second voltage vc to be greater than the level LVm4 of the first voltage vs at the first time point Tm1, in response to the switching time from the first mode to the second mode being the first time point Tm1.

Meanwhile, the pulse width modulation control circuit 430 may be configured to control the level of the second voltage vc to be constant for a certain period of time from before the first time point Tm1 to after the first time point Tm1, in response to the switching time from the first mode to the second mode being the first time point Tm1.

Meanwhile, the pulse width modulation control circuit 430 may be configured to control the level of the first voltage vs to be constant, for a certain period of time after the first time point Tm1, in response to the switching time from the first mode to the second mode being the first time point Tm1.

Meanwhile, the pulse width modulation control circuit 430 may be configured to control the pulse width of the pulse voltage GR5 applied to the inductor L to be equal to W1, for a certain period of time after the first time point Tm1, in response to the switching time from the first mode to the second mode being the first time point Tm1.

In the drawing, it is illustrated that the pulse width of the pulse voltage GR5 applied to the inductor L is the same as W1 during the periods Tm1 to Tm2, Tm3 to Tm4, and Tm5 to Tm6. Accordingly, the voltage ripple during mode switching can be reduced. In particular, the voltage ripple during mode switching between the pulse frequency modulation mode and the pulse width modulation mode can be reduced.

That is, it is possible to reduce the ripple of the output voltage due to the increase or decrease of the output voltage of the power converting device 400.

Meanwhile, at the third time point between the time point Tm1 and the time point Tm2, a high-level signal is output from the dead time controller 412, and in response to this, the current sensor 434 and the ramp output portion 436 operate respectively.

Accordingly, from the third time point to the time point Tm2, the adder 437 is configured to add the first current ICs based on the voltage from the current sensor 434, the second current Iramp based on the ramp pulse voltage from the ramp output portion 436, and the third current Iseamless based on the offset voltage from the current controller 432.

Finally, from the third time point to the time point Tm2, the first voltage vs input to one end of the input terminal of the comparator 441 appears as a ramp pulse voltage to which an offset voltage ΔVset is added, like GR3a.

Meanwhile, in response to the first voltage vs from the third time point to the time point Tm2, a pulse width modulation control signal PWM_CTRL may be output, at the time point Tm2.

Accordingly, between the third time point and the time point Tm2, a pulse voltage GR5 applied to the inductor L is applied, like GR5, and the duty of the pulse voltage GR5 at this time may be W1.

Similarly, at the fourth time point between the time point Tm3 and the time point Tm4, a high level signal is output from the dead time controller 412, and in response to this, the current sensor 434 and the ramp output portion 436 operate, respectively.

Accordingly, from the fourth time point to the time point Tm4, the adder 437 is configured to add the first current ICs based on the voltage from the current sensor 434, the second current Iramp based on the ramp pulse voltage from the ramp output portion 436, and the third current Iseamless based on the offset voltage from the current controller 432.

Eventually, from the fourth time point to the time point Tm4, the first voltage vs input to one end of the input terminal of the comparator 441 appears as a ramp pulse voltage to which an offset voltage ΔVset is added, like GR3a.

Meanwhile, in response to the first voltage vs from the fourth time point to the time point Tm4, a pulse width modulation control signal PWM_CTRL may be output at the time point Tm4.

Accordingly, between the fourth time point and the time point Tm4, a pulse voltage GR5 is applied to the inductor L, like GR5, and the duty of the pulse voltage GR5 at this time may be W1.

Similarly, at the fifth time point between the time point Tm5 and the time point Tm6, a high-level signal is output from the dead time controller 412, and in response to this, the current sensor 434 and the ramp output portion 436 operate, respectively.

Accordingly, from the fifth time point to the time point Tm6, the adder 437 is configured to add the first current ICs based on the voltage from the current sensor 434, the second current Iramp based on the ramp pulse voltage from the ramp output portion 436, and the third current Iseamless based on the offset voltage from the current controller 432.

Eventually, from the fifth time point to the time point Tm6, the first voltage vs input to one end of the input terminal of the comparator 441 appears as a ramp pulse voltage to which an offset voltage ΔVset is added, like GR3a.

Meanwhile, in response to the first voltage vs from the fifth time point to the time point Tm6, a pulse width modulation control signal PWM_CTRL may be output, at the time point Tm6.

Accordingly, between the fifth time point and the time point Tm6, a pulse voltage GR5 is applied to the inductor L, like GR5, and the duty of the pulse voltage GR5 at this time may be W1.

Meanwhile, in the drawing, since the width of the pulse voltage applied to the inductor L is the same as W1, W1, and W1, the output voltage of the power converting device 400 can be maintained constant without rising or falling, and eventually, the voltage ripple during mode switching can be reduced.

Meanwhile, referring to FIG. 7, in response to the switching time from the first mode to the second mode being the first time point Tm1, the pulse width modulation control circuit 430 may be configured to change the level of the first voltage vs, based on the offset voltage ΔVset and the ramp pulse voltage, during a certain period after the first time point Tm1. Accordingly, the voltage ripple during mode switching can be reduced.

Meanwhile, in response to the switching time from the first mode to the second mode being the first time point Tm1, the pulse width modulation control circuit 430 may be configured to change the level of the first voltage vs by changing the offset voltage ΔVset among the offset voltage ΔVset and the ramp pulse voltage, during a certain period after the first time point Tm1. Accordingly, the voltage ripple during mode switching can be reduced.

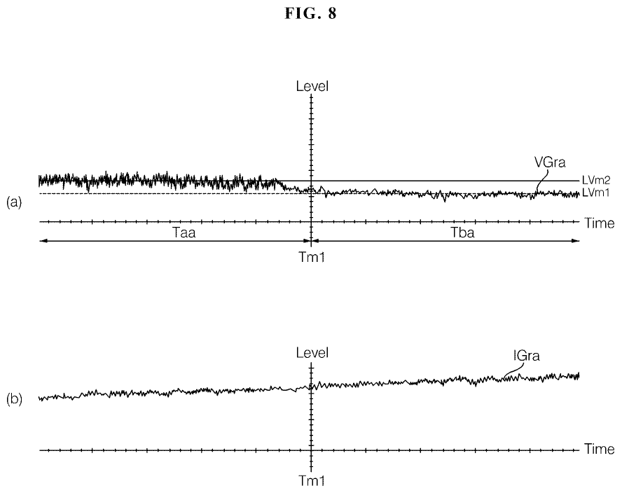

FIG. 8 is a diagram for explaining the operation of FIG. 7.

In particular, FIG. 8 illustrates an output voltage, etc., in response to switching from PFM mode to PWM mode in the power converting device 400 according to an embodiment of the present disclosure.

Referring to FIG. 8, during the Taa period before the time point Tm1, the power converting device 400 operates in the PFM mode, and during the Tba period after the time point Tm1, the power converting device 400 operates in the PWM mode.

FIG. 8(a) illustrates a waveform VGra of the output voltage of the power converting device 400, and FIG. 8(b) illustrates a waveform IGra of the load current or output current of the power converting device 400.

Meanwhile, after the Tm1 time point when the operation is switched from the PFM mode to the PWM mode, the waveform VGr of the output voltage of the power converting device 400 may partially decrease, unlike FIG. 3e.

For example, as shown in the drawing, the output voltage of the power converting device 400 in the PFM mode may be approximately LVm2, and the output voltage of the power converting device 400 in the PWM mode may be approximately LVm1 which is smaller than LVm2.

Accordingly, the voltage ripple during mode switching can be reduced. In particular, the voltage ripple during mode switching between the pulse frequency modulation mode and the pulse width modulation mode can be reduced.

Meanwhile, the power converting device 400 of FIG. 4 may be provided in the signal processing device 170 or the power supply 190 of FIG. 2.

Meanwhile, the power converting device 400 of FIG. 4 may be provided in various electronic devices.

For example, when the power converting device 400 is provided in the first electronic device, the set value of load current may be approximately 70 mA, and when the load current is a light load that is less than the set value, it may be configured to operate in the PFM mode, and when the load current is a heavy load that is greater than the set value, it may be configured to operate in the PWM mode.

At this time, the second voltage vc may be approximately 550 mV, the offset voltage ΔVset of the first voltage vs may be approximately 400 mV, and the ramp pulse voltage may be approximately 150 mV.

That is, the level of the offset voltage ΔVset of the first voltage vs may be greater than the level of the ramp pulse voltage. Accordingly, the voltage ripple during mode switching can be reduced. In particular, the voltage ripple during mode switching between the pulse frequency modulation mode and the pulse width modulation mode can be reduced.

As described above, the power conversion device, the signal processing device, and the electronic device having the same according to an embodiment of the present disclosure include a first switching element; a second switching element between the first switching element and a ground terminal; a pulse width modulation control circuit configured to output a pulse width modulation control signal based on a first voltage corresponding to a current flowing in an inductor having one end connected to the first switching element and the second switching element or a second voltage corresponding to a voltage of a capacitor connected to the other end of the inductor; and a pulse frequency modulation control circuit configured to output a pulse frequency modulation control signal based on the current flowing in the inductor or the voltage of the capacitor, in which the pulse width modulation control circuit is configured to adjust the first voltage, during mode switching between a first mode, which is a pulse frequency modulation mode, and a second mode, which is a pulse width modulation mode. Accordingly, voltage ripple during mode switching can be reduced. In particular, it is possible to reduce voltage ripple in response to switching modes between pulse frequency variable mode and pulse width variable mode.

Meanwhile, in response to switching from the first mode to the second mode, the pulse width modulation control circuit is configured to change the first voltage based on the current flowing in the inductor or the voltage of the capacitor. Accordingly, voltage ripple during mode switching can be reduced.

Meanwhile, the pulse width modulation control circuit is configured to increase the first voltage, as the current flowing in the inductor increases or the voltage of the capacitor decreases, in response to switching from the first mode to the second mode. Accordingly, voltage ripple during mode switching can be reduced.

Meanwhile, the pulse width modulation control circuit is configured to increase the first voltage and the second voltage from a second time point before the first time point, in response to a switching time from the first mode to the second mode being a first time point. Accordingly, voltage ripple during mode switching can be reduced.

Meanwhile, in response to a switching time from the first mode to the second mode being a first time point, the pulse width modulation control circuit is configured to operate from a second time point before the first time point, and control a level of the second voltage at the first time point to be greater than a level of the first voltage. Accordingly, voltage ripple during mode switching can be reduced.

Meanwhile, in response to a switching time from the first mode to the second mode being a first time point, the pulse width modulation control circuit is configured to control a pulse width of pulse voltage applied to the inductor to be constant, for a certain period of time after the first time point. Accordingly, voltage ripple during mode switching can be reduced.

Meanwhile, in response to a switching time from the first mode to the second mode being a first time point, the pulse width modulation control circuit is configured to control a level of the second voltage to be constant, for a certain period of time after the first time point. Accordingly, voltage ripple during mode switching can be reduced.

Meanwhile, in response to a switching time from the first mode to the second mode being a first time point, the pulse width modulation control circuit is configured to change a level of the first voltage corresponding to an offset voltage and a ramp pulse voltage, for a certain period of time after the first time point. Accordingly, voltage ripple during mode switching can be reduced.

Meanwhile, in response to the switching time from the first mode to the second mode being the first time point, the pulse width modulation control circuit is configured to change the level of the first voltage, by changing the offset voltage among the offset voltage and the ramp pulse voltage, for the certain period of time after the first time point. Accordingly, voltage ripple during mode switching can be reduced.

Meanwhile, the pulse width modulation control circuit includes: a current sensor configured to sense the current flowing in the inductor; a ramp output portion configured to output a ramp pulse voltage; a current controller configured to output a third current corresponding to a first current based on the current sensor and a second current based on the ramp output portion; an adder configured to add the first current, the second current, and the third current and output the first voltage; and a comparator configured to compare the first voltage and the second voltage and output the pulse width modulation control signal. Accordingly, voltage ripple during mode switching can be reduced.

Meanwhile, the pulse width modulation control circuit further includes: an error amplifier configured to operate based on the third voltage corresponding to the voltage of the capacitor and a reference voltage; and a second capacitor arranged between the first comparator and the error amplifier. Accordingly, voltage ripple during mode switching can be reduced.

Meanwhile, the pulse frequency modulation control circuit includes: a second comparator configured to operate based on a third voltage corresponding to the voltage of the capacitor and a reference voltage; a second current sensor configured to sense the current flowing in the inductor; and a multiplexer configured to output the pulse frequency modulation control signal based on an output signal of the second comparator and an output signal of the second current sensor. Accordingly, voltage ripple during mode switching can be reduced.

Meanwhile, the power converting device, the signal processing device, and the electronic device having the same according to an aspect of the present disclosure further include a switching controller configured to complementarily operate the first switching element and the second switching element, based on the pulse width modulation control signal from the pulse width modulation control circuit or the pulse frequency modulation control signal from the pulse frequency modulation control circuit. Accordingly, voltage ripple during mode switching can be reduced.

Meanwhile, the switching controller includes a second multiplexer configured to operates based on the pulse width modulation control signal from the pulse width modulation control circuit or the pulse frequency modulation control signal from the pulse frequency modulation control circuit; a multiplexer controller configured to control the second multiplexer; a dead time controller configured to control dead time control based on a signal from the second multiplexer; and a switch buffer configured to output a switching control signal to each of the first switching element and the second switching element based on signal from the dead time controller. Accordingly, voltage ripple during mode switching can be reduced.

Meanwhile, the power converting device, the signal processing device, and the electronic device having the same according to an aspect of the present disclosure further include an inductor having one end connected to the first switching element and the second switching element; and a capacitor connected to the other end of the inductor. Accordingly, voltage ripple during mode switching can be reduced.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

What is claimed is:

1. A power converting device comprising:
a first switching element;
a second switching element between the first switching element and a ground terminal;
a pulse width modulation control circuit configured to output a pulse width modulation control signal based on a first voltage corresponding to:
a current flowing in an inductor having a first end connected to the first switching element and the second switching element, or
a second voltage corresponding to a voltage of a capacitor connected to a second end of the inductor; and
a pulse frequency modulation control circuit configured to output a pulse frequency modulation control signal based on the current flowing in the inductor or the voltage of the capacitor,
wherein the pulse width modulation control circuit is configured to adjust the first voltage, during mode switching between a first mode, which is a pulse frequency modulation mode, and a second mode, which is a pulse width modulation mode.

2. The power converting device of claim 1, wherein in response to switching from the first mode to the second mode, the pulse width modulation control circuit is configured to change the first voltage, based on the current flowing in the inductor or the voltage of the capacitor.

3. The power converting device of claim 2, wherein in response to switching from the first mode to the second mode, the pulse width modulation control circuit is configured to increase the first voltage, as the current flowing in the inductor increases or the voltage of the capacitor decreases.

4. The power converting device of claim 1, wherein in response to a switching time from the first mode to the second mode being a first time point, the pulse width modulation control circuit is configured to increase the first voltage and the second voltage from a second time point before the first time point.

5. The power converting device of claim 1, wherein in response to a switching time from the first mode to the second mode being a first time point, the pulse width modulation control circuit is configured to:
operate from a second time point before the first time point, and
control a level of the second voltage at the first time point to be greater than a level of the first voltage.

6. The power converting device of claim 1, wherein in response to a switching time from the first mode to the second mode being a first time point, the pulse width modulation control circuit is configured to control a pulse width of pulse voltage applied to the inductor to be constant, for a certain period of time after the first time point.

7. The power converting device of claim 1, wherein in response to a switching time from the first mode to the second mode being a first time point, the pulse width modulation control circuit is configured to control a level of the second voltage to be constant, for a certain period of time after the first time point.

8. The power converting device of claim 1, wherein in response to a switching time from the first mode to the second mode being a first time point, the pulse width modulation control circuit is configured to change a level of the first voltage corresponding to an offset voltage and a ramp pulse voltage, for a certain period of time after the first time point.

9. The power converting device of claim 8, wherein in response to the switching time from the first mode to the second mode being the first time point, the pulse width modulation control circuit is configured to change the level of the first voltage, by changing the offset voltage among the offset voltage and the ramp pulse voltage, for the certain period of time after the first time point.

10. The power converting device of claim 1, wherein the pulse width modulation control circuit comprises:
a current sensor configured to sense the current flowing in the inductor;
a ramp output portion configured to output a ramp pulse voltage;
a current controller configured to output a third current corresponding to:
a first current based on the current sensor, and
a second current based on the ramp output portion;
an adder configured to add the first current, the second current, and the third current and output the first voltage; and
a first comparator configured to compare the first voltage and the second voltage and output the pulse width modulation control signal.

11. The power converting device of claim 10, wherein the pulse width modulation control circuit further comprises:
an error amplifier configured to operate based on a third voltage corresponding to the voltage of the capacitor and a reference voltage; and
a second capacitor arranged between the first comparator and the error amplifier.

12. The power converting device of claim 1, wherein the pulse frequency modulation control circuit comprises:
a second comparator configured to operate based on a third voltage corresponding to the voltage of the capacitor and a reference voltage;
a second current sensor configured to sense the current flowing in the inductor; and
a multiplexer configured to output the pulse frequency modulation control signal based on:
an output signal of the second comparator, and
an output signal of the second current sensor.

13. The power converting device of claim 1, further comprising:
a switching controller configured to complementarily operate the first switching element and the second switching element, based on:
the pulse width modulation control signal from the pulse width modulation control circuit, or
the pulse frequency modulation control signal from the pulse frequency modulation control circuit.

14. The power converting device of claim 13, wherein the switching controller comprises a second multiplexer configured to operate based on:
the pulse width modulation control signal from the pulse width modulation control circuit, or
the pulse frequency modulation control signal from the pulse frequency modulation control circuit;
a multiplexer controller configured to control the second multiplexer;
a dead time controller configured to control dead time control based on a signal from the second multiplexer; and
a switch buffer configured to output a switching control signal to each of the first switching element and the second switching element based on a signal from the dead time controller.

15. The power converting device of claim 1, further comprising:
the inductor having the first end connected to the first switching element and the second switching element; and
the capacitor connected to the second end of the inductor.

16. A signal processing device comprising a power converting device
wherein the power converting device comprises:
a first switching element;
a second switching element between the first switching element and a ground terminal;
a pulse width modulation control circuit configured to output a pulse width modulation control signal based on a first voltage corresponding to:
a current flowing in an inductor having a first end connected to the first switching element and the second switching element, or
a second voltage corresponding to a voltage of a capacitor connected to a second end of the inductor; and
a pulse frequency modulation control circuit configured to output a pulse frequency modulation control signal based on the current flowing in the inductor or the voltage of the capacitor,
wherein the pulse width modulation control circuit is configured to adjust the first voltage, during mode switching between a first mode, which is a pulse frequency modulation mode, and a second mode, which is a pulse width modulation mode.

17. An electronic device comprising:
a power supply; and
a power converting device
wherein the power converting device comprises:
a first switching element;
a second switching element between the first switching element and a ground terminal;
a pulse width modulation control circuit configured to output a pulse width modulation control signal based on a first voltage corresponding to:
a current flowing in an inductor having a first end connected to the first switching element and the second switching element, or
a second voltage corresponding to a voltage of a capacitor connected to a second end of the inductor; and
a pulse frequency modulation control circuit configured to output a pulse frequency modulation control signal based on the current flowing in the inductor or the voltage of the capacitor,
wherein the pulse width modulation control circuit is configured to adjust the first voltage, during mode switching between a first mode, which is a pulse frequency modulation mode, and a second mode, which is a pulse width modulation mode.

18. The electronic device of claim 17, wherein the pulse width modulation control circuit comprises:
a current sensor configured to sense the current flowing in the inductor;
a ramp output portion configured to output a ramp pulse voltage;
a current controller configured to output a third current corresponding to:
a first current based on the current sensor, and
a second current based on the ramp output portion;
an adder configured to add the first current, the second current, and the third current and output the first voltage; and
a first comparator configured to compare the first voltage and the second voltage and output the pulse width modulation control signal.

19. The electronic device of claim 18, wherein the pulse width modulation control circuit further comprises:
an error amplifier configured to operate based on a third voltage corresponding to the voltage of the capacitor and a reference voltage; and
a second capacitor arranged between the first comparator and the error amplifier.

20. The electronic device of claim 17, wherein the pulse frequency modulation control circuit comprises:
a second comparator configured to operate based on a third voltage corresponding to the voltage of the capacitor and a reference voltage;
a second current sensor configured to sense the current flowing in the inductor; and
a multiplexer configured to output the pulse frequency modulation control signal based on:
an output signal of the second comparator, and
an output signal of the second current sensor.
